(19) United States
(12) Patent Application Publication
(10) Pub. No.: US 2024/0212919 A1
(43) Pub. Date: Jun. 27, 2024

(54) COIL DEVICE

(71) Applicant: TDK CORPORATION, Tokyo (JP)

(72) Inventors: Taichi WATANABE, Tokyo (JP); Tatsuya SATO, Tokyo (JP); Yugo ASAI, Tokyo (JP); Daisuke URABE, Tokyo (JP); Keigo HIGASHIDA, Tokyo (JP); Hanako YOSHINO, Tokyo (JP); Takashi ARASAWA, Tokyo (JP)

(73) Assignee: TDK CORPORATION, Tokyo (JP)

(21) Appl. No.: 18/542,964

(22) Filed: Dec. 18, 2023

(30) Foreign Application Priority Data
Dec. 21, 2022 (JP) 2022-204689

(51) Int. Cl. H01F 27/28; H01F 27/29; H01F 27/30

(52) U.S. Cl. CPC H01F 27/2828; H01F 27/29; H01F 27/306

(57) ABSTRACT

A coil device includes a coil, a core, and a terminal fitting. The coil includes a winding portion and a lead portion led out from the winding portion. The core includes a winding core portion provided with the winding portion and a flange portion formed at an end in a first direction parallel to an axis of the winding core portion. The terminal fitting is provided with an engagement portion for engaging with the flange portion. The flange portion includes a first side surface located on one side in a second direction parallel to a mounting surface of the flange portion and a second side surface located on the other side in the second direction. The engagement portion is disposed from the first side surface to the second side surface and connected to the lead portion.

### BACKGROUND OF THE INVENTION

The present invention relates to a coil device including a terminal fitting.

As shown in Patent Document 1, a coil device in which a terminal fitting is provided on a flange portion of a core is conventionally known. In this coil device, the terminal fitting includes an engagement portion for engaging with the flange portion. The engagement portion includes a mounting portion disposed on a lower surface (mounting surface) of the flange portion, a wire connection portion disposed on an upper surface (surface opposite to the mounting surface) of the flange portion, and a main body portion disposed on an outer end surface of the flange portion. The mounting portion is connected to a land pattern of a substrate, the wire connection portion is connected to a lead portion of a coil, and the main body portion is disposed perpendicularly to the substrate.

In the coil device of Patent Document 1, the fixing strength between the terminal fitting and the flange portion can be increased by engaging the engagement portion with the flange portion. Also, since the lead portion of the coil can be connected to the engagement portion, there is no need to provide the terminal fitting with a wire connection portion separately from the engagement portion, and the terminal fitting and further the coil device can be downsized.

By the way, in the coil device of Patent Document 1, when the terminal fitting is attached to the flange portion, the engagement portion may rotate (pivot) around the axis of the main body portion and be fixed to the flange portion in a direction different from a desired direction. In this case, when the coil device is mounted on the substrate, it may be difficult to dispose the mounting portion at a desired position on the land pattern of the substrate.

Patent Document 1: JP2005056934 (A)

### BRIEF SUMMARY OF THE INVENTION

The present invention has been achieved under such circumstances. It is an object of the invention to provide a coil device having a small size and a high attachment stability of a terminal fitting to a flange portion.

To achieve the above object, a coil device according to the present invention comprises:
a coil including:
   a winding portion; and
   a lead portion led out from the winding portion;
a core including:
   a winding core portion provided with the winding portion; and
   a flange portion formed at an end in a first direction parallel to an axis of the winding core portion; and
a terminal fitting provided with an engagement portion for engaging with the flange portion,
wherein
   the flange portion includes:
      a first side surface located on one side in a second direction parallel to a mounting surface of the flange portion; and
      a second side surface located on the other side in the second direction, and
   the engagement portion is disposed from the first side surface to the second side surface and connected to the lead portion.

In the coil device according to the present invention, the engagement portion is disposed from the first side surface to the second side surface of the flange portion.

Thus, a portion of the engagement portion disposed on the first side surface and a portion of the engagement portion disposed on the second side surface function as stoppers (rotation stoppers), and the engagement portion is less likely to rotate (pivot) within a plane parallel to the mounting surface. Thus, when the terminal fitting is attached to the flange portion, the engagement portion can be fixed to the flange portion in a desired direction, and it is possible to enhance the attachment stability of the terminal fitting to the flange portion. Also, since the lead portion is connected to the engagement portion, there is no need to provide the terminal fitting with a wire connection portion separately from the engagement portion, and the terminal fitting and further the coil device can be downsized.

The engagement portion may include a first side portion opposing to the first side surface, and the lead portion may be connected to an outer surface of the first side portion facing outward in the second direction. In this case, the lead portion can be led out over a short distance. Thus, the length of the lead portion can be reduced, and the DC resistance and the stray capacitance of the lead portion can be reduced. Moreover, the disconnection of the lead portion can be prevented.

The engagement portion may include a first side portion opposing to the first side surface, the first side surface may be provided with a first notch portion, and the first side portion may be disposed in the first notch portion. In this case, the first side portion is less likely to be exposed more outward than one end of the flange portion in the second direction. Thus, the size of the coil device in the second direction can be reduced, and the coil device can be downsized.

The engagement portion may include a second side portion opposing to the second side surface, the second side surface may be provided with a second notch portion, and the second side portion may be disposed in the second notch portion. In this case, the second side portion is less likely to be exposed more outward than the other end of the flange portion in the second direction. Thus, the size of the coil device in the second direction can be reduced, and the coil device can be further downsized.

The first notch portion may be located on one side of the first side surface, which is a side close to the mounting surface, and the second notch portion may be located on one side of the second side surface, which is a side close to the mounting surface. In this case, the main portions of the terminal fitting, such as the first side portion disposed in the first notch portion and the second side portion disposed in the second notch portion, can be arranged closer to the mounting surface, and the terminal fitting can be downsized.

A depth of the first notch portion from the first side surface along the second direction may be larger than a depth of the second notch portion from the second side surface along the second direction. For example, when the lead portion is connected to the first side portion, with the above-mentioned configuration, the first side portion and the lead portion connected thereto are less likely to be exposed more outward than one end of the flange portion in the second direction. Thus, the size of the coil device in the second direction can be reduced, and the coil device can be downsized.

The engagement portion may be engaged with the flange portion at a position closer to the mounting surface than to a mounting opposite surface opposite to the mounting surface of the flange portion. In this case, the main portions of the terminal fitting, such as the engagement portion, can be arranged closer to the mounting surface, and the terminal fitting can be downsized.

The lead portion may be connected to an outer surface of the first side portion facing outward in the second direction by a conductive connection portion, and at least a part of the conductive connection portion may be disposed in the first notch portion. In this case, the conductive connection portion is less likely to be exposed more outward than one end of the flange portion in the second direction. Thus, the size of the coil device in the second direction can be reduced, and the coil device can be further downsized. Note that, the whole of the conductive connection portion may be disposed in the first notch portion. In this case, it is possible to prevent dimensional variations of the coil device in the second direction due to variations in the shape of the conductive connection portion.

At least a part of the conductive connection portion may be hidden by the flange portion when the flange is viewed from the opposite side to the mounting surface along a third direction perpendicular to the mounting surface. In this case, at least a part of the conductive connection portion can be prevented from being exposed more outward than an outer edge of the flange portion. Thus, the size of the coil device can be reduced, and the coil device can be downsized.

The engagement portion may include a first side portion opposing to the first side surface, and a protrusion protruding toward the first side surface may be formed on an inner surface of the first side surface facing inward in the second direction. In this case, the protrusion functions as a stopper (rotation stopper), and the engagement portion is thus less likely to rotate (pivot) within a plane parallel to the mounting surface.

The first side surface may be provided with a concave portion for engaging with the protrusion. When the protrusion is engaged with the concave portion, the engagement portion is further less likely to rotate (pivot) within a plane parallel to the mounting surface.

The terminal fitting may include a mounting portion for being disposed on the mounting surface, the mounting portion may include a first section and a second section, and the first section and the second section may be separated with a gap in the second direction. In this case, the area of the mounting portion can be reduced depending on the size of the gap. This makes it possible to reduce the area of a land pattern of a substrate connected to the mounting portion and to reduce the stray capacitance of the land pattern.

The terminal fitting may include a mounting portion for being disposed on the mounting surface, and the mounting portion may be offset from a center of the mounting surface in the second direction to the other side in the second direction. For example, when the lead portion is connected to one side (the above-mentioned first side portion) of the engagement portion in the second direction, with the above-mentioned configuration, solder or the like connecting the mounting portion and the substrate is less likely to attach to the lead portion, and the disconnection of the lead portion can be prevented.

The engagement portion may include: a first side portion opposing to the first side surface; and a caulking piece for caulking the lead portion led to the first side portion, an end of the caulking piece may be connected to the first side portion, and a position of the end of the caulking piece may be equal to a position of the end of the winding core portion located closer to the mounting surface of the flange portion with respect to a third direction perpendicular to the mounting surface. In this case, for example the lead portion can be led out straight from the end of the winding core portion toward the end of the caulking piece. Also, the lead portion can be caulked with the end of the caulking piece (the root of the caulking piece), and it is possible to prevent positional displacement of the lead portion.

The engagement portion may include a main body portion and an extended portion arranged on an outer end surface of the flange portion, the main body portion may be located between the first side portion and the second side portion, and the extended portion may extend from the main body portion toward the opposite side to the mounting surface along a third direction perpendicular to the mounting surface. In this case, the contact area between the outer end surface of the flange portion and the engagement portion can be increased by the extended portion, and it is thus possible to increase the fixing strength between the terminal fitting and the flange portion.

The flange portion may include a first convex portion and a second convex portion protruding outward in the first direction from the outer end surface of the flange portion, the first convex portion may be disposed on one side of the flange portion in the second direction, the second convex portion may be disposed on the other side of the flange portion in the second direction, and the extended portion may be disposed between the first convex portion and the second convex portion. In this case, the position of the extended portion is limited to between the first convex portion and the second convex portion in the second direction. Thus, it is possible to prevent positional displacement of the engagement portion to one side or the other side in the second direction.

The coil device according to the present invention may further comprise a plate core for being attached to a mounting opposite surface opposite to the mounting surface of the flange portion. The inductance characteristics of the coil device can be improved by attaching the plate core to the flange portion. Also, in the present embodiment, the engagement portion is not engaged with the mounting surface or the mounting opposite surface, but is engaged with the first side surface and the second side surface. Thus, unlike Patent Document 1, it is not necessary to cut the mounting opposite surface or the plate core for the purpose of preventing interference between the engagement portion (or the lead portion, etc. connected to the engagement portion) and the plate core. Thus, it is possible to secure the area of the bonding surface between the mounting opposite surface and the plate core, and in this respect as well, the inductance characteristics of the coil device can be improved. Moreover, it is possible to secure the bonding strength between the mounting opposite surface and the plate core.

### BRIEF DESCRIPTION OF THE DRAWING(S)

FIG. 1A is a perspective view of a coil device according to First Embodiment;

FIG. 1B is a side view of the coil device shown in FIG. 1A viewed from the Y-axis direction;

FIG. 1C is a side view of the coil device shown in FIG. 1A viewed from the X-axis direction;

FIG. 1D is a plane view of the coil device shown in FIG. 1A;

FIG. 1E is a bottom view of the coil device shown in FIG. 1A;

FIG. 2 is a perspective view of a core shown in FIG. 1A;

FIG. 3A is a perspective view of a terminal shown in FIG. 1A;

FIG. 3B is a side view of a modified example of the terminal shown in FIG. 3A viewed from the X-axis direction; and

FIG. 4 is a perspective view of a coil device according to Second Embodiment.

### DETAILED DESCRIPTION OF THE INVENTION

Hereinafter, embodiments of the present invention are described with reference to the figures. Note that, the illustrated contents are merely schematically and exemplarily illustrated for understanding the present invention, and the appearance, dimensional ratio, etc. may be different from the actual one. Moreover, the present invention is not limited to the following embodiments.

### First Embodiment

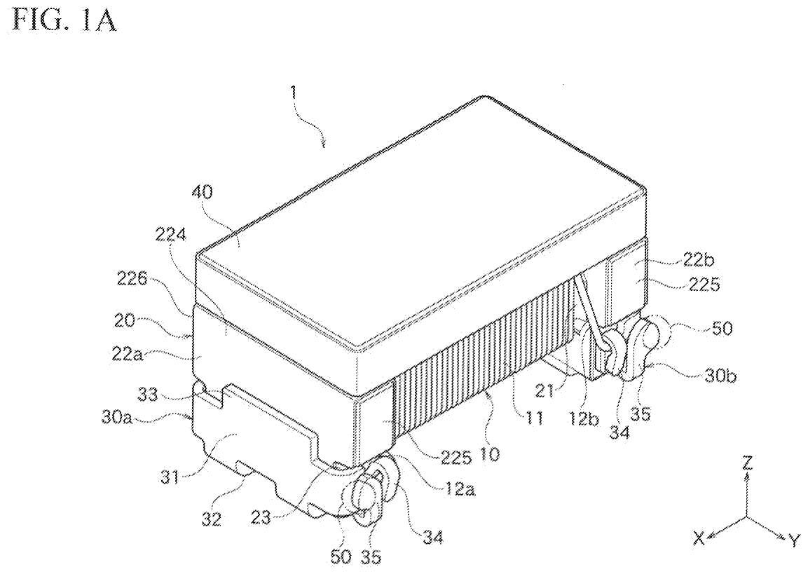

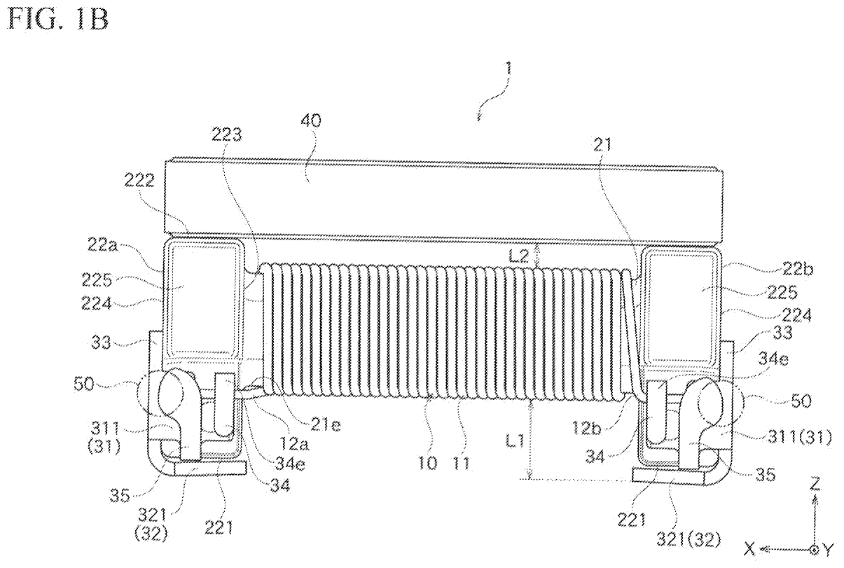

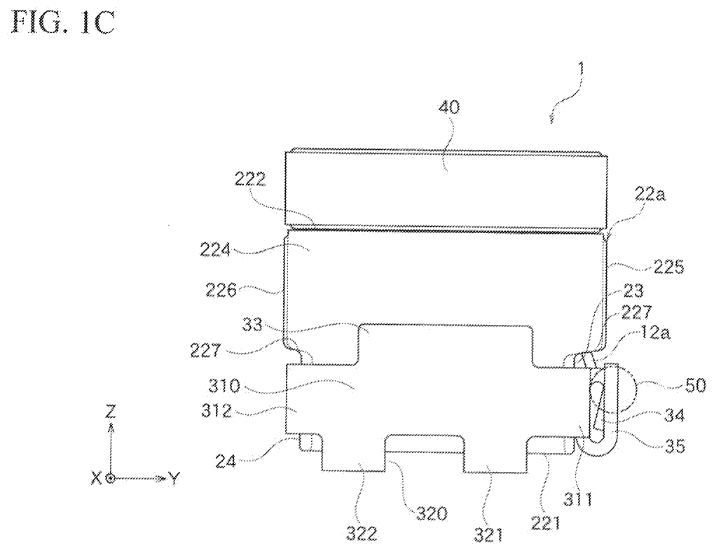

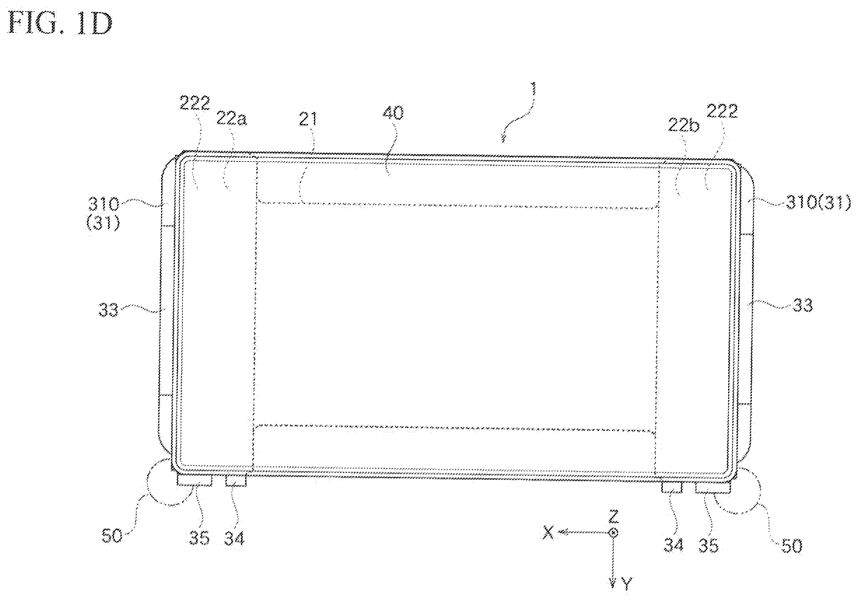

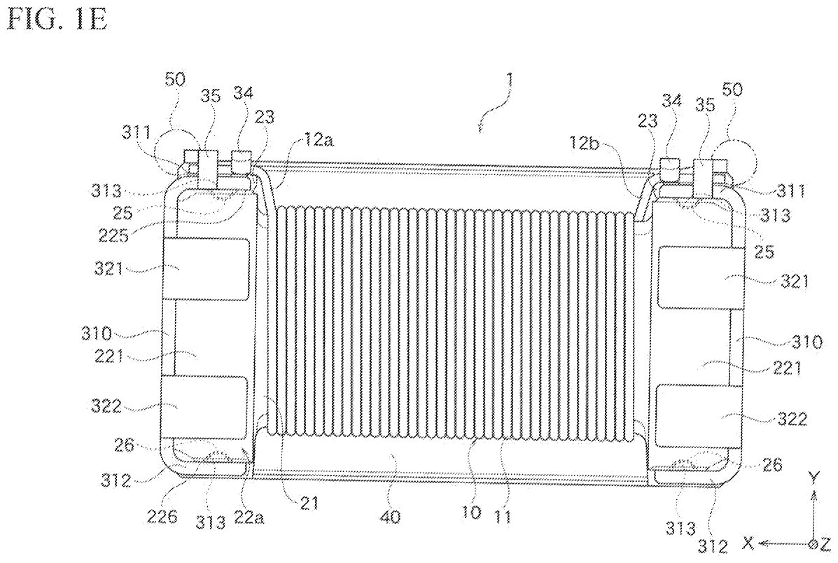

A coil device 1 shown in FIG. 1A functions, for example, as an inductor and is installed in electric sources, etc. of various electrical devices. The coil device 1 includes a coil 10, a core 20, and terminal fittings 30a and 30b. In addition to these members, the coil device 1 may include a plate core 40.

The coil 10 includes a winding portion 11 formed by a wire wound in a coil shape and lead portions 12a and 12b led out from the winding portion 11. The wire may be an insulated wire, such as a copper wire coated with an insulating film. The diameter of the wire is not limited and is, for example, 10 to 300 μm. The coating may be removed from the ends of the lead portions 12a and 12b.

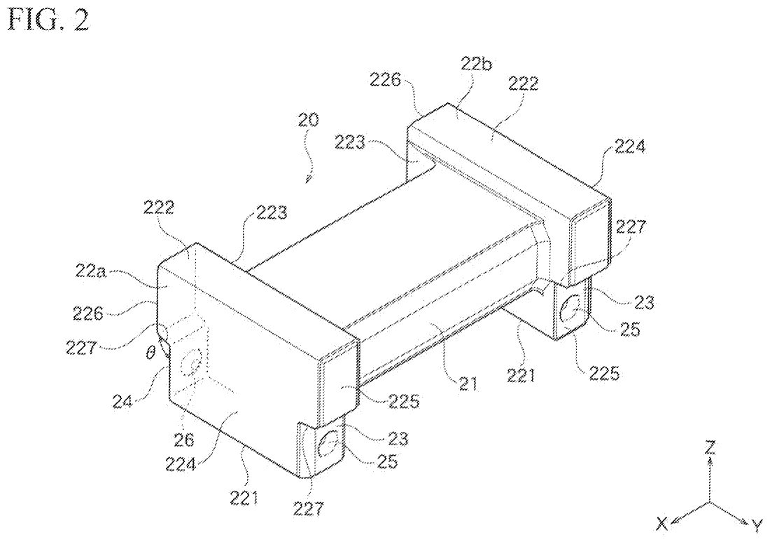

As shown in FIG. 2, the core 20 is a drum core and includes a winding core portion 21 and flange portions 22a and 22b. The material of the core 20 is a magnetic material such as metal and ferrite, but is not limited. In FIG. 2, etc., the X-axis is an axis parallel to the axis of the winding core portion 21. The Y-axis is an axis perpendicular to the axis of the winding core portion 21 when the core 20 is viewed in plan. The Z-axis is an axis perpendicular to the X-axis and the Y-axis. Hereinafter, regarding each of the X-axis, Y-axis, and Z-axis, the side toward the center of the core 20 is referred to as the “inner side”, and the side away from the center of the core 20 is referred to as the “outer side”. The size of the core 20 is not limited. For example, the length of the core 20 in the X-axis direction is 1 to 6 mm, the length of the core 20 in the Y-axis direction is 0.5 to 4 mm, and the length of the core 20 in the Z-axis direction is 0.5 to 3 mm.

Note that, in the present embodiment, the wording of “parallel” is not limited to cases where multiple objects are strictly parallel and also includes cases where multiple objects are substantially parallel (e.g., cases where there are errors within ±5 degrees between the multiple objects). Also, the wording of “perpendicular” or “orthogonal” is not limited to cases where multiple objects are strictly perpendicular and also includes cases where multiple objects are substantially perpendicular (e.g., cases where there are errors within ±5 degrees between the multiple objects).

As shown in FIG. 1B, the winding core portion 21 may be offset from the center of the inner end surface of the flange portion 22a (or the flange portion 22b) in the Z-axis direction to the positive side in the Z-axis (the side where the plate core 40 is located). Here, L2<L1 is satisfied, where L1 is a distance between the winding core portion 21 (or the winding portion 11 wound around the winding core portion 21) and the bottom surface of the mounting portion 32 of the terminal fitting 30b, and L2 is a distance between the winding core portion 21 (or the winding portion 11 wound around the winding core portion 21) and the bottom surface of the plate core 40. Note that, the winding core portion 21 may be connected to the center of the inner end surface of the flange portion 22a (or the flange portion 22b) in the Z-axis direction.

The winding portion 11 is provided around the winding core portion 21. The cross-sectional shape of the winding core portion 21 perpendicular to its axial direction is octagonal, but may be another polygonal shape (e.g., quadrangular or hexagonal), circular, or elliptical. The flange portion 22a is formed at one end of the winding core portion 21 in its axial direction, and the flange portion 22b is formed at the other end of the winding core portion 21 in its axial direction. The flange portion 22a and the flange portion 22b have a symmetrical shape (same shape). Hereinafter, for the purpose of preventing duplicate description, common matters between the flange portions 22a and 22b may be described only for the flange portion 22a.

As shown in FIG. 2, the flange portion 22a includes a mounting surface 221, a mounting opposite surface 222, an inner end surface 223, an outer end surface 224, a first side surface 225, and a second side surface 226. Likewise, the flange portion 22b includes a mounting surface 221, a mounting opposite surface 222, an inner end surface 223, an outer end surface 224, a first side surface 225, and a second side surface 226.

The mounting surface 221 is located on one side of the flange portion 22a in the Z-axis direction, and the mounting opposite surface 222 is located on the other side of the flange portion 22a in the Z-axis direction. The mounting surface 221 and the mounting opposite surface 222 oppose to each other in the Z-axis direction. The mounting surface 221 is a surface opposing to a substrate (not shown) on which the coil device 1 is mounted. The mounting surface 221 and the mounting opposite surface 222 are, for example, flat surfaces parallel to the XY plane.

The inner end surface 223 is located on one side of the flange portion 22a in the X-axis direction, and the outer end surface 224 is located on the other side of the flange portion 22a in the X-axis direction. The inner end surface 223 and the outer end surface 224 oppose to each other in the X-axis direction. The inner end surface 223 is a surface for connecting to the tube portion 21. The first side surface 225 is located on one side of the flange portion 22a in the Y-axis direction, and the second side surface 226 is located on the other side of the flange portion 22a in the Y-axis direction. The first side surface 225 and the second side surface 226 oppose to each other in the Y-axis direction.

A first notch portion 23 may be formed on the first side surface 225, and a second notch portion 24 may be formed on the second side surface 226. The first notch portion 23 is a notch recessed inward in the Y-axis direction from the first side surface 225. The second notch portion 24 is a notch recessed inward in the Y-axis direction from the second side surface 226. The first notch portion 23 and the second notch portion 24 oppose to each other in the Y-axis direction.

In the present embodiment, the first notch portion 23 is located on one side of the first side surface 225 in the Z-axis direction, which is a side close to the mounting surface 221 (the negative side of the first side surface 225 in the Z-axis direction). More specifically, the first notch portion 23 is formed as a whole closer to the mounting surface 221 than the center of the first side surface 225 in the Z-axis direction.

However, the shape of the first notch portion 23 is not limited to the shape shown in FIG. 2. For example, a part of the first notch portion 23 may be located closer to the mounting opposite surface 222 than the center of the first side surface 225 in the Z-axis direction. The length of the first notch portion 23 in the Z-axis direction is not limited and is ½ or less of the length of the flange portion 22a in the Z-axis direction.

The second notch portion 24 is located on one side of the second side surface 226 in the Z-axis direction, which is a side close to the mounting surface 221 (on the negative side of the second side surface 226 in the Z-axis direction). More specifically, the second notch portion 24 is formed as a whole closer to the mounting surface 221 than the center of the second side surface 226 in the Z-axis direction. However, the shape of the second notch portion 24 is not limited to the shape shown in FIG. 2. For example, a part of the second notch portion 24 may be located closer to the mounting opposite surface 222 than the center of the second side surface 226 in the Z-axis direction. The length of the second notch portion 24 in the Z-axis direction is not limited and is ½ or less of the length of the flange portion 22a in the Z-axis direction.

The depth of the first notch portion 23 from the first side surface 225 in the Y-axis direction is larger than the depth of the second notch portion 24 from the second side surface 226 in the Y-axis direction. The depth of the first notch portion 23 from the first side surface 225 in the Y-axis direction is, for example, larger than one time the depth of the second notch portion 24 from the second side surface 226 in the Y-axis direction and may be 1.5 times or more or 2 times or more the depth of the second notch portion 24 from the second side surface 226 in the Y-axis direction. However, these depths may be equal to each other. Alternatively, the latter depth may be larger than the former depth.

The first side surface 225 may be provided with a step forming surface 227, and the first side surface 225 may be formed in a step shape. A part of the terminal fitting 30a is disposed closer to the mounting surface 221 than the step forming surface 227 on the first side surface 225 (see FIG. 1A). The second side surface 226 may be provided with a step forming surface 227, and the second side surface 226 may be formed in a step shape. A part of the terminal fitting 30a is disposed closer to the mounting surface 221 than the step forming surface 227 on the second side surface 226 (see FIG. 1A). The angle θ formed by the step forming surface 227 and the second side surface 226 (the same applies to the first side surface 225) is not limited, but is 90°≤θ≤120°.

The first side surface 225 may be provided with a first concave portion 25. The first concave portion 25 is formed at the position of the first notch portion 23 on the first side surface 225 and is located closer to the mounting surface 221 than the step forming surface 227. The second side surface 226 may be provided with a second concave portion 26. The second concave portion 26 is formed at the position of the second notch portion 24 on the second side surface 226 and is located closer to the mounting surface 221 than the step forming surface 227. Although details are described below, protrusions formed on the terminal fitting 30a engage with the first concave portion 25 and the second concave portion 26.

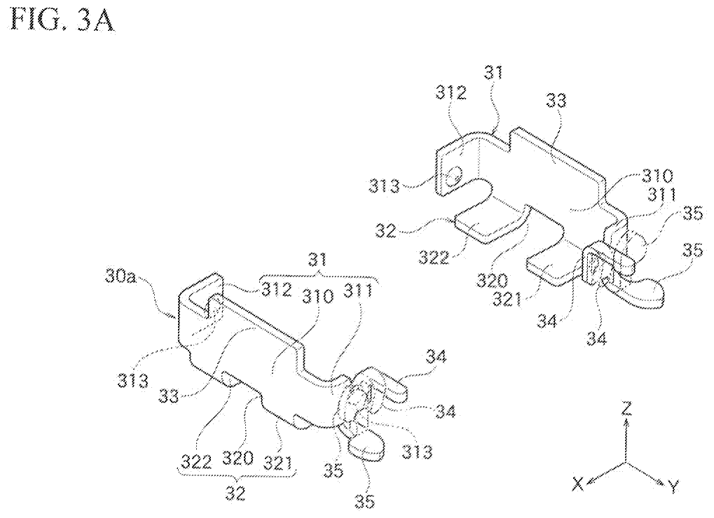

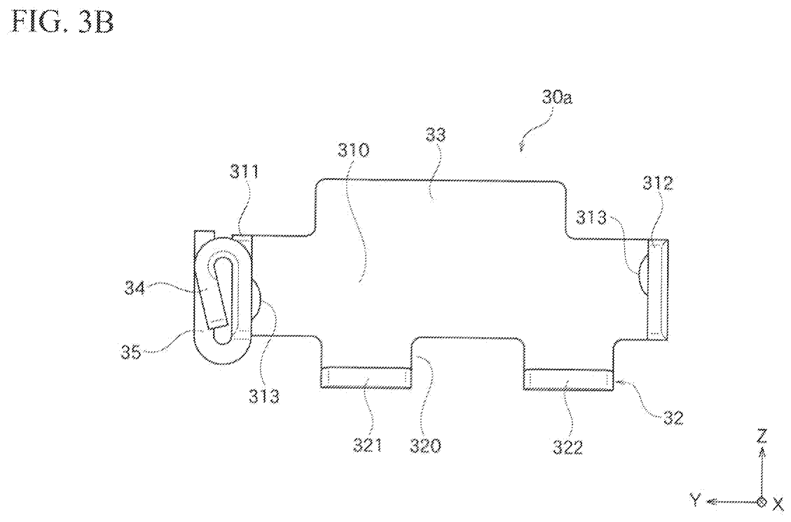

As shown in FIG. 3A, each of the terminal fittings 30a and 30b includes an engagement portion 31. In addition to the engagement portion 31, each of the terminal fittings 30a and 30b may include a mounting portion 32, an extended portion 33, a first caulking portion (first caulking piece) 34, and a second caulking portion (second caulking piece) 35. As shown in FIG. 1A, the terminal fitting 30a is attached to the flange portion 22a, and the terminal fitting 30b is attached to the flange portion 22b. The terminal fitting 30a and the terminal fitting 30b are arranged opposite to each other along the X-axis. As shown in FIG. 3A, the terminal fitting 30a and the terminal fitting 30b have mirror-symmetrical shapes with respect to the YZ plane, for example, when they are arranged opposite to each other along the X-axis. However, the terminal fitting 30a and the terminal fitting 30b may have the same shape. Note that, in the present embodiment, the wording of “same” or “equal” is not limited to cases where multiple objects are strictly the same and also includes cases where multiple objects are substantially the same (e.g., cases where there are errors within ±5% or ±10% between physical quantities of the multiple objects).

The terminal fittings 30a and 30b may be made of a conductor such as metal. A plating film of Sn, Ni, etc. may be formed on the surfaces of the terminal fittings 30a and 30b. The thickness of each of the terminal fittings 30a and 30b is not limited, but is 50 to 300 μm.

Each constituent of the engagement portion 31, the mounting portion 32, the extended portion 33, the first caulking portion 34, and the second caulking portion 35 of the terminal fitting 30a is the same as each constituent of the engagement portion 31, the mounting portion 32, the extended portion 33, the first caulking portion 34, and the second caulking portion 35 of the terminal fitting 30b, but may be different from each constituent of the engagement portion 31, the mounting portion 32, the extended portion 33, the first caulking portion 34, and the second caulking portion 35 of the terminal fitting 30b. Hereinafter, each constituent mentioned above is described for the terminal fitting 30a. If necessary, however, each constituent mentioned above is also described for the terminal fitting 30b.

The engagement portion 31 is a portion for engaging with the flange portion 22a and has a C shape. As shown in FIG. 1C, the engagement portion 31 is disposed from the first side surface 225 to the second side surface 226. For more detail, the engagement portion 31 is disposed so as to cross over the outer end surface 224, the first side surface 225, and the second side surface 226. The engagement portion 31 engages with the flange portion 22a so as to sandwich the first side surface 225 and the second side surface 226. That is, the engagement portion 31 is a so-called horizontal engagement type engagement portion and is different from a so-called vertical engagement type engagement portion (see Patent Document 1). The engagement portion 31 may be joined to the outer end surface 224 with, for example, an adhesive. As shown in FIG. 1A, the engagement portion 31 of the terminal fitting 30a is connected to the lead portion 12a of the coil 10, and the engagement portion 31 of the terminal fitting 30b is connected to the lead portion 12b of the coil 10.

As shown in FIG. 1B, the engagement portion 31 is engaged with the flange portion 22a on the side closer to the mounting surface 221 than the mounting opposite surface 222. Thus, the main portions of the terminal fitting 30a, such as the engagement portion 31 and the mounting portion 32, can be arranged on the mounting surface 221 side, and the terminal fitting 30a can be downsized. In the present embodiment, the engagement portion 31 is disposed closer to the mounting surface 221 than the center of the flange portion 22a in the Z-axis direction and is not disposed closer to the mounting opposite surface 222 than the center of the flange portion 22a in the Z-axis direction.

As shown in FIG. 3A, the engagement portion 31 includes a main body portion 310, a first side portion 311, and a second side portion 312. As shown in FIG. 1C, the main body portion 310 is a portion disposed opposite to the outer end surface 224 of the flange portion 22a. The main body portion 310 is located between the first side portion 311 and the second side portion 312. The main body portion 310 extends along the Y-axis and connects the first side portion 311 and the second side portion 312 along the Y-axis. The axis of the main body portion 310 (the axis connecting the first side portion 311 and the second side portion 312) is disposed in parallel to the mounting surface 221 or a mounting substrate (not shown). The main body portion 310 is disposed closer to the mounting surface 221 than to the mounting opposite surface 222. More specifically, the main body portion 310 is disposed as a whole closer to the mounting surface 221 than the center of the outer end surface 224 in the Z-axis direction.

As shown in FIG. 1B and FIG. 1E, the first side portion 311 is a portion disposed opposite to the first side surface 225 of the flange portion 22a. The first side portion 311 may be in contact with the first side surface 225, or a gap may be formed between the first side portion 311 and the first side surface 225. The first side portion 311 is formed at one end of the main body portion 310 in the Y-axis direction. The first side portion 311 extends (bends) in a direction perpendicular to the main body portion 310. The length of the first side portion 311 in the X-axis direction may be equal to the length of the first side surface 225 in the X-axis direction.

As shown in FIG. 1C, the first side portion 311 is disposed in the first notch portion 23. Thus, the first side portion 311 is not exposed more outward (the positive side in the Y-axis direction) than the one end of the flange portion 22a in the Y-axis direction, but is disposed more inward than the first side surface 225 in the Y-axis direction (however, a portion of the first side surface 225 located closer to the mounting opposite surface 222 than the step forming surface 227). Thus, in the present embodiment, the size of the coil device 1 in the Y-axis direction can be reduced, and the coil device 1 can be downsized.

The first side portion 311 is disposed closer to the mounting surface 221 than the mounting opposite surface 222. More specifically, the first side portion 311 is disposed as a whole closer to the mounting surface 221 than the center of the first side surface 225 in the Z-axis direction.

As shown in FIG. 3A, the first side portion 311 is provided with the first caulking portion 34 and the second caulking portion 35. As shown in FIG. 1B, the first portion 34 and the second caulking portion 35 of the terminal fitting 30a caulk the lead portion 12a led out to the first side portion 311 of the flange portion 22a. The first caulking portion 34 and the second caulking portion 35 of the terminal fitting 30b caulk the lead portion 12b led out to the first side portion 311 of the flange portion 22b. The end of the first caulking portion 34 is connected to the end of the first side portion 311 on the positive side in the Z-axis direction, and the end of the second caulking portion 35 is connected to the end of the first side portion 311 on the negative side in the Z-axis direction. That is, each end of the first caulking portion 34 and the second caulking portion 35 is located on the opposite side of the first side portion 311 in the Z-axis direction.

The first caulking portion 34 and the second caulking portion 35 are arranged so as to be positionally displaced in the X-axis direction. The first caulking portion 34 is disposed closer to the inner end surface 223 than the outer end surface 224. Meanwhile, the second caulking portion 35 is disposed closer to the outer end surface 224 than the inner end surface 223. Thus, different positions of the lead portion 12a can be caulked with the first caulking portion 34 and the second caulking portion 35.

As shown in FIG. 3A, the first caulking portion 34 is formed bendably and can bend from the state shown by the solid line (the state where the lead portion 12a is not caulked) to the state shown by the two-dot chain line (the state where the lead portion 12a is caulked). Likewise, the second caulking portion 35 is formed bendably and can bend from the state shown by the solid line (the state where the lead portion 12a is not caulked) to the state shown by the two-dot chain line (the state where the lead portion 12a is caulked).

As shown in FIG. 1B, the first caulking portion 34 is provided on the first side portion 311 so as to temporarily fix the lead portion 12a. The second caulking portion 35 is provided on the first side portion 311 so as to permanently fix the lead portion 12a.

The lead portion 12a is disposed on the outer surface of the first side portion 311 facing outward in the Y-axis direction and is caulked with the first caulking portion 34 and the second caulking portion 35. In this state, the lead portion 12a is integrated with the second caulking portion 35 by laser welding.

The connection portion between the lead portion 12a and the second caulking portion 35 may be provided with a welded portion (welded ball) 50. The lead portion 12a is connected to the outer surface of the first side portion 311 by the welded portion 50. The welded portion 50 is a conductive connection portion having conductivity and connecting the lead portion 12a and the second caulking portion 35. The lead portion 12a may be connected to the second caulking portion 35 using other conductive connection portions, such as solder and conductive adhesive. The welded portion 50 is formed so as to cover a part of the second caulking portion 35 (particularly, the tip of the second caulking portion 35), but may be formed so as to cover the whole of the second caulking portion 35. Note that, the welded portion 50 is not formed at the connection portion between the lead portion 12a and the first caulking portion 34.

As in the present embodiment, when the lead portion 12a is connected to the outer surface of the first side portion 311, the lead portion 12a can be led out from the winding core portion 21 over a short distance, compared to when the lead portion 12a is connected to a portion other than the first side portion 311 (e.g., the mounting portion 32). Thus, the length of the lead portion 12a can be reduced, and the DC resistance and the stray capacitance of the lead portion 12a can be reduced. Moreover, solder or the like attached to the mounting portion 32 is less likely to be in contact with the lead portion 12a, and the disconnection of the lead portion 12a can be prevented.

Mainly from the viewpoint of having a space for forming the welded portion 50, the second caulking portion 35 may be formed wider in the X-axis direction than the first caulking portion 34, particularly at the tip. Moreover, the second caulking portion 35 may be formed longer than the first caulking portion 34 in the Z-axis direction. Note that, at least one of the first caulking portion 34 and the second caulking portion 35 is not essential and may be omitted. In this case, the lead portion 12a may be connected to the outer surface of the first side portion 311 by, for example, laser welding, solder, conductive adhesive, thermocompression bonding, ultrasonic bonding, resistance brazing, or ultraviolet curing resin bonding.

As shown in FIG. 1E, the lead portion 12a disposed on the outer surface of the first side portion 311 of the flange portion 22a is disposed in the first notch portion 23 of the flange portion 22a. Also, the lead portion 12b disposed on the outer surface of the first side portion 311 of the flange portion 22b is disposed in the first notch portion 23 of the flange portion 22b. In this case, the lead portions 12a and 12b are less likely to be exposed more outward (the positive side in the Y-axis direction) than one ends of the flange portions 22a and 22b in the Y-axis direction. Thus, the size of the coil device 1 in the Y-axis direction can be reduced, and the coil device 1 can be downsized. However, at least a part of the lead portion 12a may protrude outward in the Y-axis direction (the positive side in the Y-axis direction) from the first notch portion 23. Likewise, at least a part of the lead portion 12b may protrude outward in the Y-axis direction (the positive side in the Y-axis direction) from the first notch portion 23.

As shown in FIG. 1C and FIG. 1E, at least a part of the welded portion 50 may be disposed in the first notch portion 23 of the flange portion 22a. Also, at least a part of the welded portion 50 may be disposed in the first notch portion 23 of the flange portion 22b. In this case, the welded portion 50 is less likely to be exposed more outward (the positive side in the Y-axis direction) than one end of the flange portion 22a or 22b in the Y-axis direction. Thus, the size of the coil device 1 in the Y-axis direction can be reduced, and the coil device 1 can be downsized.

Note that, the whole of the welded portion 50 may be disposed in the first notch portion 23 of the flange portion 22a. Also, the whole of the welded portion 50 may be disposed in the first notch portion 23 of the flange portion 22b. In this case, it is possible to prevent dimensional variations of the coil device 1 in the Y-axis direction due to variations in the shape of the welded portion 50.

A part of the welded portion 50 protrudes more outward in the X-axis direction than the outer end surface 224 of the flange portion 22a, but the welded portion 50 may be located more inward in the X-axis direction than the outer end surface 224. Also, a part of the welded portion 50 protrudes more outward in the X-axis direction than the outer end surface 224 of the flange portion 22b, but the welded portion 50 may be located more inward in the X-axis direction than the outer end surface 224. In this case, the size of the coil device 1 in the X-axis direction can be reduced, and the coil device 1 can be downsized.

As shown in FIG. 1D, when the flange portion 22a is viewed from the opposite side to the mounting surface 221 (i.e., the mounting opposite surface 222 side) along the Z-axis direction (the direction perpendicular to the mounting surface 221 in FIG. 2), at least a part of the welded portion 50 may be hidden by the flange portion 22a. Also, when the flange portion 22a is viewed from the opposite side to the mounting surface 221 along the Z-axis direction, at least a part of the welded portion 50 may be hidden by the plate core 40.

Likewise, when the flange portion 22b is viewed from the opposite side to the mounting surface 221 (i.e., the mounting opposite surface 222 side) along the Z-axis direction (the direction perpendicular to the mounting surface 221 in FIG. 2), at least a part of the welded portion 50 may be hidden by the flange portion 22b. Also, when the flange portion 22b is viewed from the opposite side to the mounting surface 221 along the Z-axis direction, at least a part of the welded portion 50 may be hidden by the plate core 40.

In this case, at least a part of the welded portion 50 can be prevented from being exposed more outward than the outer edge of the flange portion 22a or 22b. Thus, the size of the coil device 1 can be reduced, and the coil device 1 can be downsized.

As shown in FIG. 1D and FIG. 1E, the first caulking portion 34 and the second caulking portion 35 are exposed outward (the positive side in the Y-axis direction) from one end of the flange portion 22a in the Y-axis direction. However, at least a part of the first caulking portion 34 may be disposed in the first notch portion 23 so as not to be exposed more outward than one end of the flange portion 22a in the Y-axis direction (the positive side in the Y-axis direction). Also, at least a part of the second caulking portion 35 may be disposed in the first notch portion 23 so as not to be exposed more outward than one end of the flange portion 22a in the Y-axis direction (the positive side in the Y-axis direction).

As shown in FIG. 1B, with respect to the Z-axis direction, the position of an end (root) 34e of the first caulking portion 34 is completely or substantially equal to the position of an end 21e of the winding core portion 21 located on the mounting surface 221 side. The position of the end (root) 34e of the first caulking portion 34 may be positionally displaced by a predetermined distance L from the position of the end 21e of the winding core portion 21 toward the positive side in the Z-axis direction or the negative side in the Z-axis direction. For example, 0<L≤D or 0<L≤2D is satisfied, where D is a diameter of the wire.

In this case, the lead portion 12a can be led out straight from the end 21e of the winding core portion 21 toward the end 34e of the first caulking portion 34, for example, along the X-axis. Also, the lead portion 12a can be caulked with the end 34e of the first caulking portion 34 (the root of the first caulking portion 34), and it is possible to prevent positional displacement of the lead portion 12a. In the present embodiment, both of the lead portions 12a and 12b are led out from the end 21e of the winding core portion 21 toward the end 34e of the first caulking portion 34 along the X-axis without excessively bending.

As shown in FIG. 1E and FIG. 3, the second side portion 312 is a portion disposed so as to oppose to the second side surface 226 of the flange portion 22a. The second side portion 312 may be in contact with the second side surface 226, or a gap may be formed between the second side portion 312 and the second side surface 226. The second side portion 312 is formed at the other end of the main body portion 310 in the Y-axis direction (the end on the negative side in the Y-axis direction). The second side portion 312 extends in a direction perpendicular to the main body portion 310. The length of the second side portion 312 in the X-axis direction may be equal to the length of the second side surface 226 in the X-axis direction.

As shown in FIG. 1C, the second side portion 312 is disposed in the second notch portion 24. Thus, the second side portion 312 is not exposed more outward (the negative side in the Y-axis direction) than the other end of the flange portion 22a in the Y-axis direction, but is disposed more inward than the second side surface 226 in the Y-axis direction (however, a portion of the second side surfaces 226 located closer to the mounting opposite surface 222 than the step forming surface 227). Thus, in the present embodiment, the size of the coil device 1 in the Y-axis direction can be reduced, and the coil device 1 can be downsized.

The second side portion 312 is disposed closer to the mounting surface 221 than the mounting opposite surface 222. More specifically, the second side portion 312 is disposed as a whole closer to the mounting surface 221 than the center of the second side surface 226 in the Z-axis direction.

As described above, the depth of the first notch portion 23 from the first side surface 225 in the Y-axis direction is larger than the depth of the second notch portion 24 from the second side surface 226 in the Y-axis direction. Thus, the first side portion 311 disposed in the first notch portion 23 is closer to the center of the flange portion 22a in the Y-axis direction than the second side portion 312 disposed in the second notch portion 24. In the present embodiment, since the depth of the first notch portion 23 from the first side surface 225 in the Y-axis direction is relatively large, the first side portion 311 and the lead portion 12a connected thereto are less likely to be exposed more outward (the positive side in the Y-axis direction) than one end of the flange portion 22a in the Y-axis direction. Thus, the size of the coil device 1 in the Y-axis direction can be reduced, and the coil device 1 can be downsized.

As shown in FIG. 3A, a protrusion 313 is formed on the inner surface of the first side portion 311 facing inward in the Y-axis direction. Likewise, a protrusion 313 is formed on the inner surface of the second side portion 312 facing inward in the Y-axis direction. The shape of the protrusion 313 is not limited, but is a tapered shape that tapers toward the tip. The shape of the protrusion 313 viewed from the Y-axis direction may be circular, oval, or polygonal. As shown in FIG. 1E, the protrusions 313 formed on the first side portions 311 protrude toward the first side surfaces 225 and are engaged with the first concave portions 25 formed on the first side surfaces 225. The protrusions 313 formed on the second side portions 312 protrude toward the second side surfaces 226 and are engaged with the second concave portions 26 formed on the second side surfaces 226.

The protrusions 313 function as stoppers (rotation stoppers). Thus, when the protrusions 313 are engaged with the first concave portions 25 or the second concave portions 26, the engagement portions 31 are less likely to rotate (pivot) within a plane parallel to the mounting surface 221 (within a plane parallel to the XY plane). Note that, the protrusions 313 are not essential, and the protrusion 313 formed on at least one of the first side portion 311 and the second side portion 312 may be omitted.

In the example shown in FIG. 3A, the protrusion 313 formed on the first side portion 311 and the protrusion 313 formed on the second side portion 312 are located at the same height from the bottom of the main body portion 310 along the Z-axis. As shown in FIG. 3B, however, the protrusion 313 formed on the first side portion 311 and the protrusion 313 formed on the second side portion 312 may be positionally displaced along the Z-axis. In the example shown in FIG. 3B, the former protrusion 313 is located closer to the mounting surface 221 (FIG. 2) than the latter protrusion 313, but may be located closer to the mounting opposite surface 222 (FIG. 2). In this case, the engagement portion 31 is further less likely to rotate (pivot) within a plane parallel to the mounting surface 221 (FIG. 2) (within a plane parallel to the XY plane).

As shown in FIG. 3A, the extended portion 33 is formed at the end of the main body portion 310 in the Z-axis direction and is located on the opposite side of the mounting portion 32 in the Z-axis direction. The extended portion 33 extends in a direction parallel to the main body portion 310. The extended portion 33 has a rectangular shape when viewed from the X-axis direction, but may have a square or another polygonal shape.

As shown in FIG. 1C, the extended portion 33 is disposed on the outer end surface 224 of the flange portion 22a. The extended portion 33 extends from the main body portion 310 toward the opposite side of the mounting surface 221 along the Z-axis. The length of the extended portion 33 in the Z-axis direction is not limited, but is ¼ times or more and 3/2 times or less the length of the main body portion 310 in the Z-axis direction. The extended portion 33 may extend to the end of the outer end surface 224 in the Z-axis direction (the intersection between the outer end surface 224 and the mounting opposite surface 222). In the present embodiment, the contact area between the outer end surface 224 and the engagement portion 31 can be increased by the extended portion 33, and it is thus possible to increase the fixing strength between the terminal fitting 30a and the flange portion 22a. Also, the fixing strength between the terminal fitting 30a and the flange portion 22a can be further increased by, for example, bonding the extended portion 33 to the outer end surface 224 with an adhesive or the like. Note that, the extended portion 33 is not essential and may be omitted from the terminal fitting 30a or 30b.

As shown in FIG. 3A, the mounting portion 32 is formed at the end of the main body portion 310 in the Z-axis direction and is located on the opposite side to the extended portion 33 in the Z-axis direction. The mounting portion 32 includes a first section 321 and a second section 322. The shape of the first section 321 and the shape of the second section 322 are the same, but may be different from each other. The first section 321 and the second section 322 protrude inward in the X-axis direction and extend (bend) in a direction perpendicular to the main body portion 310. The first section 321 and the second section 322 are separated from each other with a gap 320 in the Y-axis direction. The length of the gap 320 in the Y-axis direction may be equal to or larger than the length of the first section 321 or the second section 322 in the X-axis direction.

In the present embodiment, the area of the mounting portion 32 can be reduced depending on the size of the gap 320. This makes it possible to reduce the area of a land pattern of a substrate (not shown) connected to the mounting portion 32 and to reduce the stray capacitance of the land pattern. Note that, the mounting portion 32 is connected to the substrate with a connecting material, such as solder and conductive adhesive. The main body portion 310 may be formed with fillets of the connecting material.

As shown in FIG. 1E, the first section 321 and the second section 322 are arranged on the mounting surface 221. The length of each of the first section 321 and the second section 322 in the X-axis direction may be equal to the length of the mounting surface 221 in the X-axis direction. The mounting portion 32 is offset as a whole from the center of the mounting surface 221 (or the axis of the winding core portion 21) in the Y-axis direction to the negative side in the Y-axis direction. Thus, the distance between the first section 321 and the first side portion 311 is larger than the distance between the second section 322 and the second side portion 312. As in the present embodiment, when the lead portion 12a is connected to the first side portion 311, by offsetting the mounting portion 32 to the second side portion 312, the solder etc. attached to the first section 321 is less likely to be in contact with the lead portion 12a, and the disconnection of the lead portion 12a can be prevented. Also, the coil device 1 can be balanced on one side and the other side in the Y-axis direction, and the mounting stability of the coil device 1 can be enhanced.

As shown in FIG. 1C, the first section 321 and the second section 322 are arranged between the first side portion 311 and the second side portion 312 in the Y-axis direction. Since the first section 321 is located on the inner side of the first side portion 311 in the Y-axis direction, the intersection between the mounting surface 221 and the first side surface 225 of the flange portion 22a is exposed from the terminal fitting 30a. Also, since the second portion 322 is located on the inner side of the second side portion 312 in the Y-axis direction, the intersection between the mounting surface 221 and the second side surface 226 of the flange portion 22a is exposed from the terminal fitting 30a. Also, the mounting surface 221 is exposed from the terminal fitting 30a at the position of the gap 320. In such a manner, in the present embodiment, the mounting surface 221 is exposed from the terminal fitting 30a at a plurality of locations on the mounting surface 221. Thus, the solder etc. attached to the mounting portion 32 (particularly, the first section 321) is less likely to be in contact with the lead portion 12a, and the disconnection, etc. of the lead portion 12a can be prevented.

As shown in FIG. 1A, the plate core 40 has a rectangular parallelepiped shape (plate shape). The plate core 40 may be made of a material similar to that of the core 20 or may be made of a material different from that of the core 20. The plate core 40 is attached to the core 20 using, for example, an adhesive. For more detail, the plate core 40 is fixed to the mounting opposite surfaces 222 (FIG. 2) of the flange portions 22a and 22b.

As shown in FIG. 1A and FIG. 2, the inductance characteristics of the coil device 1 can be improved by attaching the plate core 40 to the flange portions 22a and 22b. Also, in the present embodiment, the engagement portion 31 is not engaged with the mounting surface 221 or the mounting opposite surface 222, but is engaged with the first side surface 225 and the second side surface 226. Thus, for example, unlike Patent Document 1, it is not necessary to cut the mounting opposite surface 222 or the plate core 40 for the purpose of preventing interference between the engagement portion 31 (or the lead portion 12a, etc. connected to the engagement portion 31) and the plate core 40. Thus, it is possible to secure the area of the bonding surface between the mounting opposite surface 222 and the plate core 40, and in this respect as well, the inductance characteristics of the coil device 1 can be improved. Moreover, it is possible to secure the bonding strength between the mounting opposite surface 222 and the plate core 40.

Next, a method of manufacturing the coil device 1 is explained. First, a wire and a plate core 40 shown in FIG. 1A, a core 20 shown in FIG. 2, and terminal fittings 30a and 30b shown in FIG. 3A are prepared. Next, as shown in FIG. 1A and FIG. 2, an engagement portion 31 of the terminal fitting 30a is disposed on an outer end surface 224, a first side surface 225, and a second side surface 226 of a flange portion 22a.

Then, the engagement portion 31 is engaged with the flange portion 22a so that the first side surface 225 and the second side surface 226 are sandwiched by the engagement portion 31. Likewise, the engagement portion 31 of the terminal fitting 30b is disposed on an outer end surface 224, a first side surface 225, and a second side surface 226 of a flange portion 22b. Then, the engagement portion 31 is engaged with the flange portion 22b so that the first side surface 225 and the second side surface 226 are sandwiched by the engagement portion 31. If necessary, the main body portion 310 (and further an extended portion 33) may be bonded to the outer end surface 224 with an adhesive or the like.

Next, the wire is wound around a winding core portion 21 to form a coil 10 including the winding portion 11 around the winding core portion 21. A lead portion 12a is led out from an end 21e (FIG. 1B) of the winding core portion 21 toward the first side surface 225 of the flange portion 22a at the same height as the end 21e. A lead portion 12b is led out from an end 21e (FIG. 1B) of the winding core portion 21 toward the first side surface 225 of the flange portion 22b at the same height as the end 21e. Note that, after forming the coil 10 around the winding core portion 21, the terminal fitting 30a may be disposed in the flange portion 22a, and the terminal fitting 30b may be disposed in the flange portion 22b.

Next, as shown in FIG. 1B, the lead portion 12a is caulked with a first caulking portion 34 of the terminal fitting 30a and is fixed (temporarily fixed) to the outer surface of the first side portion 311. Also, the lead portion 12a is caulked with a second caulking portion 35 of the terminal fitting 30a and is fixed to the outer surface of the first side portion 311. Likewise, the lead portion 12b is caulked with the first caulking portion 34 of the terminal fitting 30b and is fixed (temporarily fixed) to the outer surface of the first side portion 311. Also, the lead portion 12b is caulked with the second caulking portion 35 of the terminal fitting 30b and is fixed to the outer surface of the first side portion 311.

Next, for example, by laser welding, the lead portion 12a is connected to the second caulking portion 35 of the terminal fitting 30a, and the lead portion 12b is connected to the second caulking portion 35 of the terminal fitting 30b. Thus, by a welded portion 50, the laser portion 12a is connected to the second caulking portion 35 of the terminal fitting 30a, and the lead portion 12b is connected to the second caulking portion 35 of the terminal fitting 30b.

Next, the plate core 40 is attached to a mounting opposite surface 222 of each of the flange portions 22a and 22b using a connecting material, such as an adhesive. Accordingly, the coil device 1 shown in FIG. 1A can be manufactured.

In the coil device 1 of the present embodiment, as shown in FIG. 1A and 1C, the engagement portion 31 is disposed from the first side surface 225 to the second side surface 226 of the flange portion 22a. Thus, the first side portion 311 disposed on the first side surface 225 and the second side portion 312 disposed on the second side surface 226 function as stoppers (rotation stoppers), and the engagement portion 31 is less likely to rotate (pivot) within a plane parallel to the mounting surface 221 (within a plane parallel to the XY plane). Thus, when the terminal fitting 30a is attached to the flange portion 22a, the engagement portion 31 can be fixed to the flange portion 22a in a desired direction, and it is possible to enhance the attachment stability of the terminal fitting 30a to the flange portion 22a. Also, since the lead portion 12a is connected to the engagement portion 31 (the outer surface of the first side portion 311), there is no need to provide the terminal fitting 30a with a wire connection portion separately from the engagement portion 31, and the terminal fitting 30a and further the coil device 1 can be smaller and lower in height.

The first notch portion 23 is located on the mounting surface 221 side of the first side surface 225, and the second notch portion 24 is located on the mounting surface 221 side of the second side surface 226. Thus, the main portions of the terminal fitting 30a, such as the first side portion 311 disposed in the first notch portion 23, the second side portion 312 disposed in the second notch portion 24, and the mounting portion 32, can be arranged on the mounting surface 221 side, and the terminal fitting 30a can be downsized. Moreover, as a result of downsizing of the terminal fitting 30a, the coil device 1 can be further smaller and lower in height.

### Second Embodiment

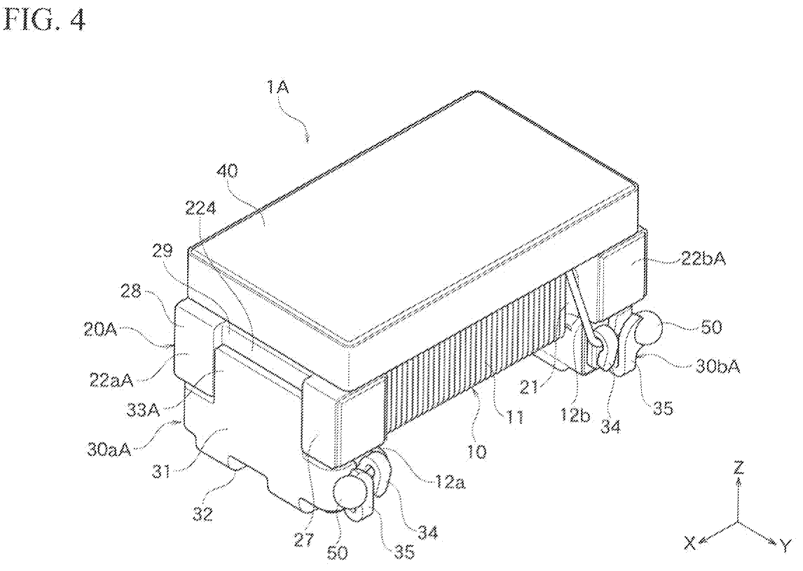

Except for the following matters, a coil device 1A according to Second Embodiment shown in FIG. 4 has configurations similar to those of the coil device 1 according to First Embodiment. Overlapping portions with the coil device 1 according to First Embodiment are provided with the same references and are not described in detail.

The coil device 1A includes a core 20A and terminal fittings 30aA and 30bA. The core 20A includes flange portions 22aA and 22bA. The flange portion 22aA includes a first convex portion 27 and a second convex portion 28 protruding outward in the X-axis direction from an outer end surface 224. The first convex portion 27 is disposed on one side of the flange portion 22aA in the Y-axis direction, and the second convex portion 28 is disposed on the other side of the flange portion 22aA in the Y-axis direction. The protrusion length of the first convex portion 27 and the second convex portion 28 from the outer end surface 224 is not limited, but is ⅓ times or more and 2 times or less the plate thickness of the terminal fitting 30aA. The shape of each of the first convex portion 27 and the second convex portion 28 viewed from the X-axis direction is quadrangular, but may be another polygonal shape.

An end surface concave portion 29 is formed between the first convex portion 27 and the second convex portion 28 in the Y-axis direction. The length of the end surface concave portion 29 in the Y-axis direction is equal to or larger than the length of an extended portion 33A in the Y-axis direction. The extended portion 33A is accommodated into the end surface concave portion 29 and is disposed between the first convex portion 27 and the second convex portion 28. Thus, the position of the extended portion 33A is limited to between the first convex portion 27 and the second convex portion 28 in the Y-axis direction. Accordingly, the first convex portion 27 and the second convex portion 28 function as stoppers and can prevent positional displacement of the engagement portion 31 to one side or the other side in the Y-axis direction.

Note that, the present invention is not limited to the above-described embodiments and can be variously modified within the scope of the present invention. For example, as shown in FIG. 1A, in each of the above-described embodiments, a single coil 10 is provided in the winding core portion 21, but a plurality of coils 10 may be provided in the winding core portion 21. In this case, depending on the number of coils 10, a plurality of terminal fittings may be installed on the flange portion 22a, or a plurality of terminal fittings may be installed on the flange portion 22b.

In each of the above-described embodiments, an application example of the coil device 1 or 1A to an inductor is described, but the coil device 1 or 1A may be applied to other electronic components (e.g., transformer).

In each of the above-described embodiments, the plate core 40 may be omitted from the coil device 1 or 1A.

### DESCRIPTION OF THE REFERENCE NUMERICAL

1, 1A . . . coil device

10 . . . coil

11 . . . winding portion

12a, 12b . . . lead portion

20, 20A... core

21 . . . winding core portion

22a, 22b, 22aA, 22bA . . . flange portion

221 . . . mounting surface

222 . . . mounting opposite surface

223 . . . inner end surface

224 . . . outer end surface

225 . . . first side surface

226 . . . second side surface

227 . . . step forming surface

23 . . . first notch portion

24 . . . second notch portion

25 . . . first concave portion

26 . . . second concave portion

27 . . . first convex portion

28 . . . second convex portion

29 . . . end surface concave portion

30a, 30b, 30aA, 30bA . . . terminal fitting

31 . . . engagement portion

310 . . . main body portion

311 . . . first side portion

312 . . . second side portion

313 . . . protrusion

32 . . . mounting portion

320 . . . gap

321 . . . first section

322 . . . second section

33, 33A . . . extended portion

34 . . . first caulking portion

35 . . . second caulking portion

40 . . . plate core

50 . . . welded ball

What is claimed is:

1. A coil device comprising:
a coil including:
a winding portion; and
a lead portion led out from the winding portion;
a core including:
a winding core portion provided with the winding portion; and
a flange portion formed at an end in a first direction parallel to an axis of the winding core portion; and
a terminal fitting provided with an engagement portion for engaging with the flange portion,
wherein
the flange portion includes:
a first side surface located on one side in a second direction parallel to a mounting surface of the flange portion; and
a second side surface located on the other side in the second direction, and
the engagement portion is disposed from the first side surface to the second side surface and connected to the lead portion.

2. The coil device according to claim 1, wherein
the engagement portion includes a first side portion opposing to the first side surface, and
the lead portion is connected to an outer surface of the first side portion facing outward in the second direction.

3. The coil device according to claim 1, wherein
the engagement portion includes a first side portion opposing to the first side surface,
the first side surface is provided with a first notch portion, and
the first side portion is disposed in the first notch portion.

4. The coil device according to claim 3, wherein
the engagement portion includes a second side portion opposing to the second side surface,
the second side surface is provided with a second notch portion, and
the second side portion is disposed in the second notch portion.

5. The coil device according to claim 4, wherein
the first notch portion is located on one side of the first side surface, which is a side close to the mounting surface, and
the second notch portion is located on one side of the second side surface, which is a side close to the mounting surface.

6. The coil device according to claim 4, wherein a depth of the first notch portion from the first side surface along the second direction is larger than a depth of the second notch portion from the second side surface along the second direction.

7. The coil device according to claim 1, wherein the engagement portion is engaged with the flange portion at a position closer to the mounting surface than to a mounting opposite surface opposite to the mounting surface of the flange portion.

8. The coil device according to claim 3, wherein
the lead portion is connected to an outer surface of the first side portion facing outward in the second direction by a conductive connection portion, and
at least a part of the conductive connection portion is disposed in the first notch portion.

9. The coil device according to claim 8, wherein at least a part of the conductive connection portion is hidden by the flange portion when the flange portion is viewed from the opposite side to the mounting surface along a third direction perpendicular to the mounting surface.

10. The coil device according to claim 1, wherein
the engagement portion includes a first side portion opposing to the first side surface, and
a protrusion protruding toward the first side surface is formed on an inner surface of the first side surface facing inward in the second direction.

11. The coil device according to claim 10, wherein the first side surface is provided with a concave portion for engaging with the protrusion.

12. The coil device according to claim 1, wherein
the terminal fitting includes a mounting portion for being disposed on the mounting surface,
the mounting portion includes a first section and a second section, and
the first section and the second section are separated with a gap in the second direction.

13. The coil device according to claim 1, wherein
the terminal fitting includes a mounting portion for being disposed on the mounting surface, and
the mounting portion is offset from a center of the mounting surface in the second direction to the other side in the second direction.

14. The coil device according to claim 1, wherein
the engagement portion includes:
a first side portion opposing to the first side surface; and
a caulking piece for caulking the lead portion led to the first side portion,
an end of the caulking piece is connected to the first side portion, and
a position of the end of the caulking piece is equal to a position of the end of the winding core portion located closer to the mounting surface of the flange portion with respect to a third direction perpendicular to the mounting surface.

15. The coil device according to claim 1, wherein
the engagement portion includes a main body portion and an extended portion arranged on an outer end surface of the flange portion,
the main body portion is located between the first side portion and the second side portion, and
the extended portion extends from the main body portion toward the opposite side to the mounting surface along a third direction perpendicular to the mounting surface.

16. The coil device according to claim 15, wherein
the flange portion includes a first convex portion and a second convex portion protruding outward in the first direction from the outer end surface of the flange portion,
the first convex portion is disposed on one side of the flange portion in the second direction,
the second convex portion is disposed on the other side of the flange portion in the second direction, and
the extended portion is disposed between the first convex portion and the second convex portion.

17. The coil device according to claim 1, further comprising a plate core for being attached to a mounting opposite surface opposite to the mounting surface of the flange portion.
